(19) United States
(12) Patent Application Publication
(10) Pub. No.: US 2017/0041076 A1
(43) Pub. Date: Feb. 9, 2017

(54) ALL-OPTICAL SIGNAL REGENERATION METHOD

(71) Applicant: ASTON UNIVERSITY, Birmingham, West Midlands (GB)

(72) Inventors: Mariia SOROKINA, Birmingham, West Midlands (GB); Sergei Konstantin TURITSYN, Oldbury, West Midlands (GB)

(73) Assignee: ASTON UNIVERSITY, Birmingham, West Midlands (GB)

(21) Appl. No.: 15/305,585

(22) PCT Filed: Apr. 21, 2015
(86) PCT No.: PCT/GB2015/051183

§ 371 Date: Oct. 20, 2016

(30) Foreign Application Priority Data
Apr. 23, 2014 (GB) 1407169.0
Aug. 15, 2014 (GB) 1414540.3

(51) Int. Cl. H04B 10/2507; H04B 10/299; H04B 10/516

(52) U.S. Cl. CPC H04B 10/2507; H04B 10/516; H04B 10/299

(57) ABSTRACT

An all-optical signal regeneration technique in which a modulation alphabet is mapped on to a set of optimised points of a regenerative transfer function. The optimised points correspond to attraction regions in the regenerative transfer function and are preferably stable. The regenerative transfer function can be selected to be the Fourier transform of an ideal regenerator, which is represented by a step-wise transfer function. Use of the Fourier transform can enable efficient regeneration of multilevel multidimensional signals. The regenerative Shannon limit—the upper bound of regeneration efficiency can also be derived.

### CROSS-REFERENCE TO RELATED APPLICATIONS

This application is the U.S. National Phase of International Patent Application Serial No. PCT/GB2015/051183, filed Apr. 21, 2015, which claims priority to British Patent Application Serial Nos. 1407169.0, filed Apr. 23, 2014 and 1414540.3, filed Aug. 15, 2014, both of which are incorporated herein by reference in their entirety.

### FIELD OF THE INVENTION

The present invention relates to methods of efficiently transmitting information across a nonlinear communication channel, e.g. an optical fibre or the like. In particular, the invention is concerned with a regenerative channel for an optical fibre having a capacity capable of exceeding the Shannon capacity of an equivalent linear additive white Gaussian noise (AWGN) channel.

### BACKGROUND OF THE INVENTION

Since Shannon derived the seminal formula for the capacity of the additive linear white Gaussian noise channel, it has commonly been interpreted as the ultimate limit of error-free information transmission rate. However, the capacity above the corresponding linear channel limit can be achieved when noise is suppressed using nonlinear elements; that is the regenerative function not available in linear systems. Regeneration is a fundamental concept that extends from biology to optical communications. All-optical regeneration of coherent signal has attracted particular attention. Surprisingly, the quantitative impact of regeneration on the Shannon capacity has remained unstudied.

Shannon capacity [1] defines the maximum amount of error-free information that can be transmitted through a channel. Though the linear Shannon limit [1] was calculated in 1948, there is no unique nonlinear Shannon limit, as nonlinearity can occur and can be designed and modified in various ways. However, the current existing estimations for lower bounds [2]-[5] on the Shannon capacity are still referenced as the nonlinear Shannon limit. The calculation of the Shannon capacity for different nonlinear channels is an open and challenging problem.

Existing optical communication systems and technologies, which are primarily responsible for global data traffic, are facing serious challenges due to nonlinear properties of fibre channels [2]-[5]. It is fair to say that the optical communications sector has reached a bifurcation point and a number of fundamentally new methods to improve information transmission are under investigation around the world (see e.g. [6]-[8] and references therein). All-optical regeneration, being an energy efficient and effective mitigation of noise impairment, attracts attention as a powerful tool for improving quality of signal transmission [9]-[19].

### SUMMARY OF THE INVENTION

The present invention proposes a new method of designing regenerative transmission systems with capacity that is higher than the corresponding linear channel. At its most general, the invention provides an all-optical signal regeneration technique in which a modulation alphabet is mapped on to a set of optimised points of a regenerative transfer function. The optimised points correspond to attraction regions in the regenerative transfer function and are preferably stable. In a preferred embodiment, the regenerative transfer function is selected to be the Fourier transform of an ideal regenerator, which is represented by a step-wise transfer function. Use of the Fourier transform can enable efficient regeneration of multilevel multidimensional signals. The regenerative Shannon limit—the upper bound of regeneration efficiency—can also be derived.

Thus, according to the invention there is provided an optical communication method comprising: encoding data on an optical signal using a modulation alphabet; transmitting the optical signal on a non-linear optical channel; regenerating the optical signal at a regeneration filter on the non-linear optical channel; receiving the optical signal at a destination; and decoding the data from the optical signal, wherein regenerating the optical signal comprises applying a regenerative transfer function T(x) to the optical signal at the regeneration filter, and wherein the regenerative transfer function T(x) satisfies the conditions: T(x*)=x*, T″(x*)=0, and |T′(x*)|<1, where x* represents each symbol of the modulation alphabet. Here, the primes are used to indicate first and second order derivatives in a conventional manner, i.e.

$${T}^{′} = \frac{d T}{d x} , and {T}^{″} = \frac{{d}^{2} T}{d {x}^{2}} .$$

Thus, the conditions for the regenerative transfer function may define a set of optimised solutions, which in turn provide each symbol of the modulation alphabet. The conditions ensure that each of the set of optimised points is a stationary point of the regenerative transfer function located within a region of attraction. As such, the regenerative transfer function has the effect of “noise squeezing”, i.e. it self-compensates the effect on noise to re-align each symbol. It is therefore not necessary to provide separate processing power that is arranged to make a hard decision about the position of a given point in a received constellation.

Preferably the regenerative transfer function T(x) satisfies the condition |r(x*)|=0 at each symbol x* of the modulation alphabet. This provides stability to the transfer function by eliminating any distortion of the optical signal caused by applying the regenerative transfer function.

The method may include regenerating the optical signal at a plurality of regeneration filters disposed in series along the non-linear communication channel. Each regeneration filter may apply the same regenerative transfer function. The noise-squeezing effect increases with the number of regeneration filters on the non-linear channel. This may increase the capacity of the channel, e.g. by enabling higher order constellations (i.e. modulation alphabets with an higher number of symbols) to be used. For example, the method of the invention may be used with a constellation of order 8.

The non-linear channel may comprise an optical waveguide. For example, the optical waveguide may be a conventional silica-based optical fibre having an optical core for transmitting the optical signal surrounded by cladding.

In one embodiment, the method including applying the regenerative transfer function to both quadratures of the optical signal, i.e. both real and imaginary parts of the optical signal. The method may therefore regenerate both the phase and amplitude of the optical signal using the same schema, which differs from known regeneration arrangements in which phase and amplitude are treated in different ways.

Applying the regenerative transfer function may thus comprise: separating two quadratures of the optical signal, applying the regenerative transfer function to each quadrature, and combining the regenerated quadratures. The quadratures may be separated using any known technique, e.g. phase sensitive amplification (PSA) or the like. Use of quadratures of the signal may enable rectangular constellation schemes to be used for the modulation alphabet, because the regenerative transfer function acts on orthogonal component of the optical signal independently. Rectangular constellations can be desirable because symbols can be packed more efficiently in them than in a circular scheme, for example.

In one embodiment, the regenerative transfer function is a Fourier transform of a step-wise regenerator function. For example, the regenerative transfer function may be of the form T(x)=x+α sin βx, where α and β are parameters determined by the configuration of the regenerative filter as discussed in detail below, and are set to ensure αβ≦1 to meet the third condition set out above. The set of optimised points for this regenerative transfer function thus occur at π(2k+1)/β where kε [symbol] . An advantage of using a Fourier transform for the regenerative transfer function is that it enables the regeneration filter to be an all-optical component, i.e. the regenerative transfer function is applied wholly within the domain of the optical signal.

Where the regenerative transfer function is of the form T(x)=x+α sin βx, the step of applying the regenerative transfer function in the regeneration filter may comprise: splitting the optical signal into a reference signal and an input signal; separating the input signal into two quadratures (e.g. corresponding to the real and imaginary parts of the input signal); applying a sine transformation to each of the two quadratures; combining the two quadratures into an output signal; and adding the output signal to the reference signal.

The step of applying a sine transformation to each of the two quadratures may comprise performing four-wave mixing with a continuous wave (i.e. coupling a continuous wave to each quadrature) and extracting an imaginary part of the result thereof. The step of mixing may be performed by propagating each quadrature and the continuous wave though a highly non-linear optical fibre (HNLF). The length of the HNLF and the frequency of the continuous wave may be selected to control parameter β.

Instead of extracting the sine transformation from the result of four-wave mixing, it is possible to couple out the cosine term (which is approximately unity at the optimised points of interest) by using a corresponding continuous wave. This may be done before or after the output signal is added to the reference signal.

The optical signal may be generated by any suitable source of optical radiation. Herein, optical radiation may mean any of ultraviolet radiation, visible radiation, and infrared radiation. Preferably the optical signal has a wavelength in the range 1260-1674 nm. Wavelengths around 1500 nm, e.g. 1400-1600 nm, are preferred.

The data may be encoded on the optical signal in any conventional manner, e.g. wavelength division multiplexing (WDM) or the like.

According to another aspect of the invention, there is provided a regeneration filter for regenerating an optical signal transmitted on an optical fibre, the regeneration filter comprising: an input for receiving an optical signal; an optical splitter for dividing the optical signal into a reference signal and an input signal; an optical separator for separating the input signal into a first quadrature and a second quadrature; an optical transformation component for applying a sine transformation to the first quadrature and the second quadrature; and an optical combiner for combining the sine transformation of the first quadrature and second quadrature, adding them to the reference signal and outputting the result from the filter. The regeneration filter thus functions to apply the Fourier transform discussed above.

### BRIEF DESCRIPTION OF THE DRAWINGS

A detailed discussion of the invention and its application is presented below with reference to the accompanying drawings, in which:

FIGS. 1(a)-(d) illustrate a regenerative transfer function y=T(x)=x+α sin(βx) shown:

FIG. 1(a) plotted with fixed β=π to provide a periodic washboard potential with a slope defined by parameter α;

FIG. 1(b) with varying α and β at x=π: higher intensity is shown by a lighter colour, the optimal values are shown by superimposed lines;

FIG. 1(c) with parameters β=π and α=1/β: the optimal set of parameters (providing maximum noise suppression) correspond to the zero-slope at the stationary points; and

FIG. 1(d) as a Gaussian conditional probability density function (pdf) P(y|x) for a channel with one filter having a transfer function (TF)

$$y = x + \frac{1}{π} sin ( π x )$$

to illustrate the regeneration effect at the points defining the signal alphabet.

FIGS. 2(a)-(d) show a regenerative channel model in which

FIG. 2(a) shows regenerative transfer functions, plotted for an ideal regenerator and a number of regenerative Fourier transforms (RFT) having the form y=x+α sin(βx) with the alphabet shown by vertical lines;

FIG. 2(b) shows a graphical interpretation of the stability analysis;

FIG. 2(c) shows a scheme with regenerative filters (denoted by F) placed equidistantly along the channel, where noise distortions are effectively filtered by the ideal regenerators (see constellations before and after noisy transmission with attraction regions shown by straight lines); and

FIG. 2(d) shows numerically calculated Shannon capacity and gain (compared to the linear additive linear white Gaussian noise channel) for RFT channels with R=20 and R=10 filters for both superstable (dashed-dotted) and stable (dotted) mappings. The upper bounds of regeneration efficiency for the given number of the ideal filters R=10 and R=20 are shown by solid curves, respectively.

FIGS. 3(a)-(b) illustrate a transmission improvement of rectangular M=4 constellations after R successive RFT transformations interleaved with noise shown:

FIG. 3(a) at the output of the R-th filter (after RFT transformation), and

FIG. 3(b) at the receiving end (when the noise of the last span is added) for the transmission lines having fixed AWGN distortion of SNR=3 dB. The level of noise suppression is more pronounced for the higher number of in-line RFT filters characterized by TF

$$y = x + \frac{1}{π} sin ( π x ) .$$

Linear unregenerated case R=0 is shown for reference.

FIGS. 4(a)-(b) illustrate a regeneration limit, where

FIG. 4(a) shows gain, the regenerative Shannon capacity ratio to the Shannon formula C_{L}=log₂(1+ρ), for the different number of regenerators, and

FIG. 4(b) shows capacity and mutual information for discrete M²-rectangular (left panel) and M-points in the ring (right panel) alphabets. The arrows show the constant capacity increase. Constellations and associated attraction regions are shown.

FIGS. 5(a)-(d) show an embodiment of a RFT that is used in the invention, in which

FIG. 5(a) shows how at first two quadratures of the field (denoted by x_{R} and x_{I}) are separated;

FIG. 5(b) shows how each quadrature undergoes a nonlinear transformation, which results in the sine transformation;

FIG. 5(c) shows how, in general, after the sine-transformation the two outputs are coupled together and added to the original wave;

FIG. 5(d) shows a simplified schematic of the proposed scheme.

FIG. 6 shows a schematic diagram of a regeneration filter that is an embodiment of the invention.

### DETAILED DESCRIPTION

The detailed discussion below discloses a theoretical framework for calculating the exact Shannon capacity (optimized over input signal distribution, as defined by Shannon) for nonlinear regenerative channels. The framework is illustrated using an example regenerative Fourier transform. The discussion goes on to calculate analytically a maximum gain in Shannon capacity due to regeneration (that is, the Shannon capacity of a system with ideal regenerators—the upper bound on all regenerative schemes). Thus, the regenerative limit, to which the capacity of any regenerative system can be compared, as analogue of the seminal linear Shannon limit, can be derived for constructive nonlinearity.

### Regenerative Mapping

The present invention is used in a technique known as regenerative mapping for designing nonlinear communication channels with capacity that exceeds the Shannon capacity of a linear additive linear white Gaussian noise (AWGN) channel.

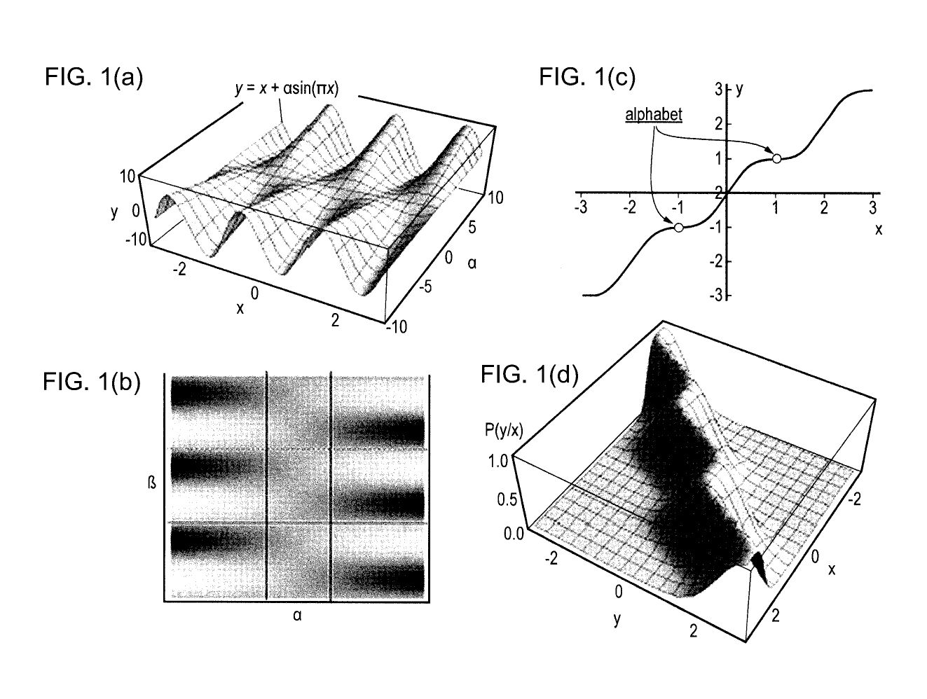

An important new feature introduced by the considered nonlinear mapping is the potential for continuous nonlinear filtering with signal regeneration without requiring a hard decision. This differs from traditional approaches based on ideal regenerators [19], which are characterized by step-like piecewise transfer function. The proposed practical example of regenerative mapping incorporates experimentally verified regenerative models [12, 20] and enables analytical optimization. Whenever the nonlinear transformation has multiple fixed points (FIG. 1(c)), the consequent interleaving of the accumulating noise with the nonlinear filter produces effective suppression of the noise (see FIG. 1(d)). The created washboard potential (FIG. 1(c)) quantizes the signal and improves transmission, with a consequent increase in capacity.

A similar idea has been discussed in multiple contexts, ranging from physical systems [21] to the interpretation of biological memory effects in terms of potentials with multiple minima [22]. In quantum theory, a qualitatively similar phenomena is known as the Zeno effect, where continuous measurement of the quantum system and associated von Neumann collapse of wave function prevents the natural dispersion of the wave function and causes the quantum system to remain in the same state [23].

Consider a regenerative channel with R identical nonlinear filters placed along the transmission line. The cascaded regeneration was demonstrated for various regenerative schemes [16-18]. The signal transmission (for simplicity, signal propagation between the regenerators is assumed to be linear) is distorted by an AWGN that is uniformly distributed along the line, which can be considered as an analogue of the random force in the time-continuous case or noise mixing with the signal during transmission through the media. The regenerative map has a set of special points that are optimal for the nonlinear filtering.

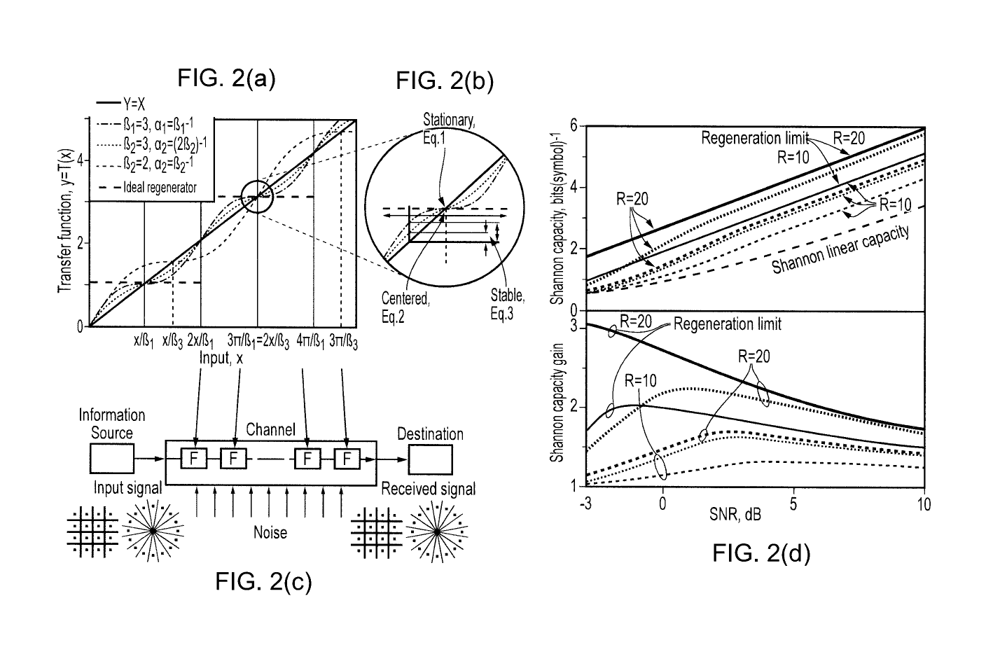

The nonlinear transformations y=T(x) (see FIGS. 2(a)-2(d)) result in the effective potential, which creates attraction regions in the signal mapping. When the points are “attracted” to the alphabet, the alphabet should remain stable. This leads to the following set of conditions imposed on the transfer function:

T[x*]=x* (1)

T″[x*]=0 (2)

|T′[x*]|<1 (3)

The first expression means that the alphabet is defined by the stationary points x* of the mapping. Next, the transfer function should change curvature at the alphabet. In other words, the alphabet point is the centre of the attraction region. The third expression reflects the stability condition; that is, the distortion of the signal points is effectively suppressed (see geometry in FIG. 2(b)). When the first derivative is equal to zero, the alphabet is called superstable.

### Regenerative Fourier Transform

The invention propose a particular scheme for the regenerative Fourier transform (RFT). The concept of RFT may be generalized to any complete orthogonal system of functions. Without any loss of generality, we use sine functions as the basis for the expansion. The input signal is described by the waveform: s=Σₗ(x_{R}_{ₗ}−ix_{I}_{ₗ})f(t−lTₛ), where summation is performed over the number of symbols l, f(t) is a carrier pulse shape and Tₛ is a symbol period. We apply RFT to each quadrature and add the original and transformed signals:

y_{R}_{ₗ}+iy_{I}_{ₗ}=[x_{R}_{ₗ}+α sin(βx_{R}_{ₗ})]+i[x_{I}_{ₗ}+α sin(βx_{I}_{ₗ})]

Integrated optics-based realization makes Fourier transform (FT) practically available for numerous emerging applications in optics [24]-[29]. Being the FT of the ideal regenerator, described by a step-wise transfer function, RFT represents the highest achievable regeneration efficiency and can be applied to multilevel multidimensional signals. The RFT mapping is shown in FIG. 2(a). According to the previously described optimization procedure, in the considered example the alphabet is placed at the points π(2k+1)/β where kε [symbol] that are stable if and only if αβ≦1. In particular, the system is superstable when αβ=1, this gives the optimum parameter values, whereas the inequality defines the suboptimal parameters range.

As indicated in [30], it is challenging to regenerate high-order constellations (higher than 32) using the conventional approach of regenerating phase and amplitude, as such constellations have tight phase-packing due to energy efficiency requirements. Therefore, a new approach for regenerating separately the two signal quadratures will be required. The proposed RFT is the first scheme to operate on both quadratures and enable an infinite number of regenerative levels. In this sense, this scheme will also potentially enable regeneration of the conventional modulation formats (like e.g. quadrature amplitude modulation).

Moreover, RFT enables a high regeneration efficiency without making a hard decision. The calculated corresponding (optimized) Shannon capacity shows that such a channel can provide a capacity above the classical Shannon capacity of the linear additive white Gaussian noise channel.

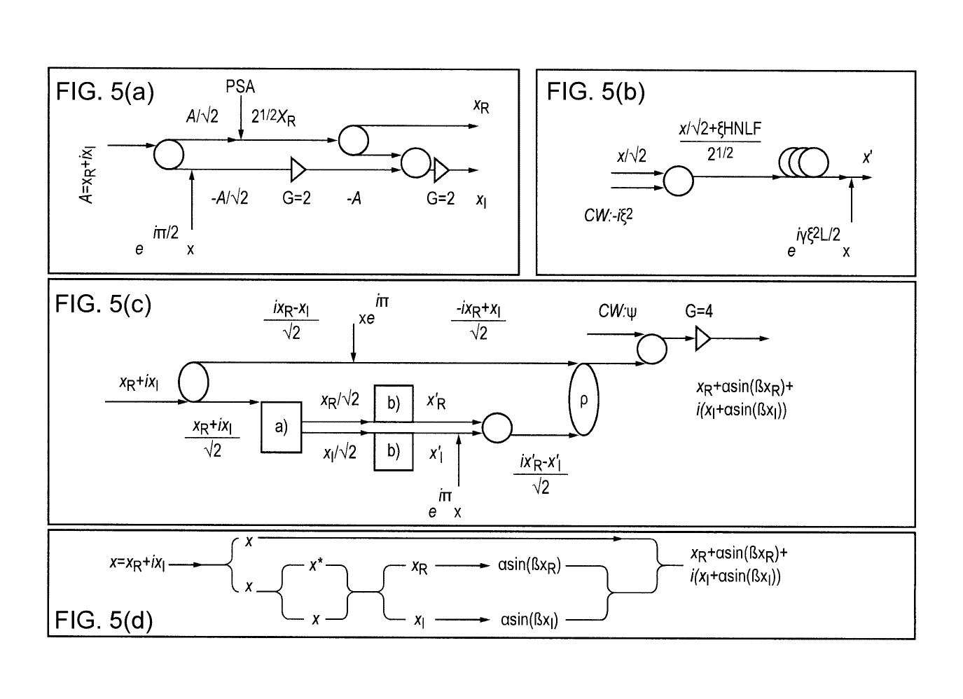

In more detail, the proposed RFT can be implemented as shown schematically in FIGS. 5(a)-(d). One starts by separating two quadratures of the field (here we used a phase sensitive amplification (PSA): Aₒᵤₜ=rₒᵤₜe^{iφ}^{ₒᵤₜ}=rᵢₙe^{iφ}^{ᵢₙ}(1+me^{-iMφ}^{ᵢₙ}) [1] with m=1 and M=2 (see FIG. 5(a)). Then, each of the coordinates (x_{R},x_{I}) is propagated through a highly nonlinear fibre (HNLF) to achieve four-wave mixing with a continuous wave ξ>>x, where ξ>0 (see FIG. 5(b)). Subsequently, the output (shifted by exp(iγLξ²/2)) will be:

$${x}_{R , I}^{′} = \frac{ξ}{\sqrt{2}} exp ( \frac{i γ L ξ {x}_{R , I}}{\sqrt{2}} ) = \frac{ξ}{\sqrt{2}} [ cos ( β {x}_{R , I} ) + i sin ( β {x}_{R , I} ) ] ,$$

where γ is a nonlinear coefficient and L is a length of HLNF, which define a parameter β=γLξ/\sqrt{2}. Taking an imaginary part of x′ will result in the sine transformation.

Alternatively, with an interest in the transformation in the vicinity of the alphabet point defined by (defined by Eqs. 1-3 above), one can approximate cos(βx_{R,I})≅1, which is valid up to the second order perturbation. The unity factor inside the brackets can be removed by coupling the wave with the corresponding constant wave. This procedure is applied to both quadratures simultaneously at the last coupler by using the wave: ψ=ξ\sqrt{ρ/4(1−ρ)}(i−1), where ρ is the coupling parameter of the previous coupler. Once the two waves (the sine transformation of the two coordinates) have been added together, they are then coupled with the original wave to finally achieve the desired RFT for both quadratures (see FIGS. 5(c) and 5(d)).

All the couplers have a splitting ratio of 0.5:0.5 (3 dB couplers), except for one coupler that has a ratio ρ:1−ρ, where ρ<<1. To restore the original power, the resulted wave is amplified with the amplifier gain G=4/(1−ρ)≅4. This achieves the RFT: y_{R,I}=x_{R,I}+α sin(βx_{R,I}), with α=ξ\sqrt{ρ/2(1−ρ)} and β=γLξ/\sqrt{2}.

As indicated in [30], it is challenging to regenerate high-order constellations (higher than 32) using the conventional approach of regenerating phase and amplitude, as such constellations have tight phase-packing due to energy efficiency requirements. Therefore, a new approach for regenerating separately the two signal quadratures will be required. The proposed RFT is the first scheme to operate on both quadratures and enable an infinite number of regenerative levels. In this sense, this scheme will also potentially enable regeneration of the conventional rectangular (QM) modulation formats. Moreover, being the Fourier transform of the ideal regenerator, it enables the highest regeneration efficiency without making a hard decision.

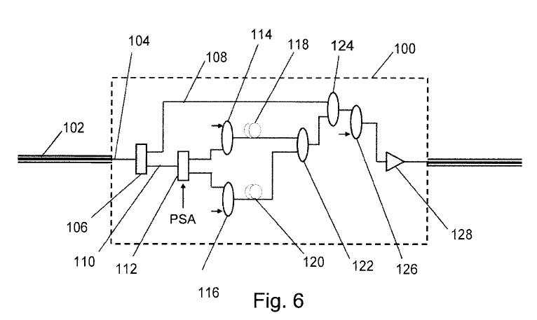

FIG. 6 shows a schematic view of a regeneration filter 100 in which the scheme outlined above can be implemented. The regeneration filter 100 is connected on an optical fibre 102, which conveys an optical signal to be regenerated. The regeneration filter 100 operates on the optical signal in the optical domain; it is an all-optical component.

The regeneration filter 100 has an input 104 for receiving the optical signal from the optical fibre 102. The received optical signal is delivered to an optical splitter 106 which splits the optical signal equally being a reference signal on a first path 108 and an input signal on a second path 110.

The input signal is deliver to an optical separator 112, which acts to divide the input signal into two quadratures, i.e. into sub-signals corresponding to orthogonal (e.g. real and imaginary) components of the original optical signal. The optical separator 112 may be configured as shown in FIG. 5(a), discussed above.

Each quadrature output from the optical separator 112 is delivered to an input of a respective optical transformation component, which is arranged to apply a sine transformation to its respective quadrature. In this embodiment, each optical transformation component comprises an optical coupler 114, 116 arranged to couple its respective quadrature with a continuous wave signal ξ into a respective highly non-linear fibre HNLF length 118, 120. The result of this arrangement is a four-wave mixing as discussed above, which includes the sine transformation required for each quadrature.

The output from the HNLF lengths 118, 120 are received in an optical combiner. In this embodiment, the optical combiner comprises a first optical coupler 122 that recombines the quadratures following transformation, and a second optical coupler 124 for adding the reference signal to the recombined quadratures.

In this embodiment, the quadratures at this point still include a cosine term from the four-wave mixing. This is removed from the output of the second optical coupler 124 by coupling that signal with a continuous wave ψ at a third optical coupler 126. The continuous wave ψ is arranged to cancel the first order approximation of the cosine term. This function may be applied at any time after the four wave mixing, so the third optical coupler 126 may be considered as part of the optical transformation component.

Finally the regeneration filter 100 may include an amplifier 128 for amplifying the signal before it is output from the regeneration filter 100 back into the optical fibre 102.

As shown in FIG. 2(c), a plurality of regeneration filters F may be disposed in series along a non-linear channel.

### Shannon Capacity

The definition of the Shannon capacity for an arbitrary channel (in what follows, capacity C is per unit bandwidth) involves maximizing the mutual information functional [1]:

$$C = {max}_{P ( x )} \int DxDyP ( x ) P ( y \vert x ) {log}_{2} \frac{P ( y \vert x )}{\int DxP ( x ) P ( y \vert x )} \qquad ( 4 )$$

over all valid input probability distributions P(x) subject to the power constraint ∫DxP(x)|x|²≦S. Here, the statistical properties of the channel are given by the conditional output-input probability density function (pdf) P(y|x).

Shannon capacity (Eq. 4) of the considered systems is a function of the signal-to-noise ratio (SNR), the number of nonlinear filters R and the parameters of nonlinear mapping. SNR is defined here as the ratio of the input signal power S to the noise added linearly to the signal during transmission at each node k=1, . . . , R: SNR=S/N, where the accumulated noise is given by N=ΣNₖ with k being a temporal [31]-[32] or spatial index.

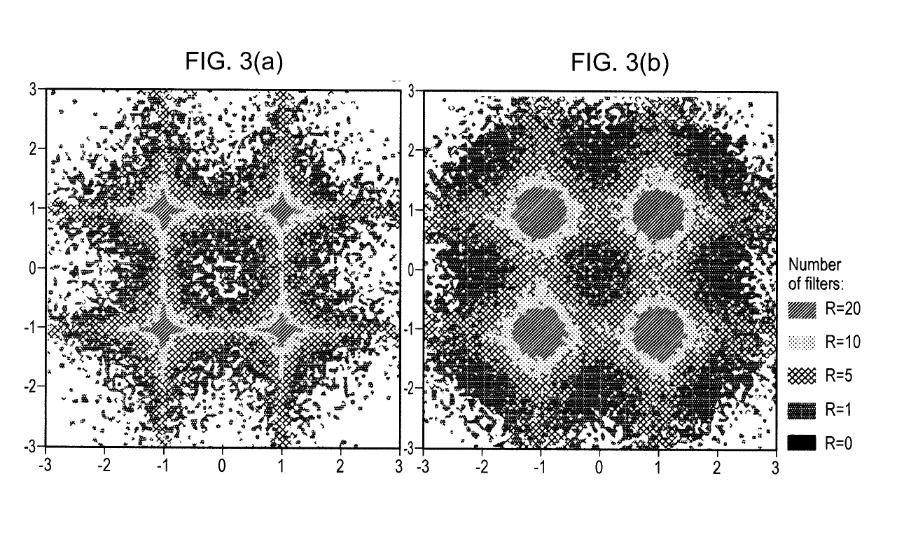

Note that in the nonlinear communication system the definition of the in-line SNR is a nontrivial issue, due to the mixing of signal with noise during propagation. The introduced SNR has the meaning of the signal-to-noise ratio in the respective linear system in the absence of nonlinear in-line elements. This enables the comparison between the performance of the considered system and the corresponding linear AWGN channel with the same noise level. Evidently, the effect of noise squeezing is enhanced as the number of regenerators/nonlinear filters increases (see FIGS. 3(a)-3(b)). To quantify the overall effect, we studied the capacity of the source-destination transmission as a function of the SNR that incorporates the resulting power of all added noise at the source-destination link, which is fundamentally different from the decode-and-forward channel model.

The numerically calculated Shannon capacity for the considered system demonstrates visible capacity gain over the Shannon capacity of the linear AWGN channel. In the limit of a large SNR and/or large number of nonlinear filters all regenerative schemes tend towards asymptotic behaviour, when the gain gap between regenerative and linear AWGN channel capacity is constant. Using the method of steepest descent, we derive the capacity increase for the n-dimensional channel with the RFT transfer function for the sub-optimal parameters relation (see Eq. 3) q=αβ<1:

$${lim}_{SNR -> ∞} Δ {C}_{S} = Δ {C}_{R} ( R ) - \frac{n}{2} {log}_{2} ( \frac{1 - {( 1 - q )}^{2 ( R + 1 )}}{1 - {( 1 - q )}^{2}} )$$

### Regenerative Limit

The capacity analysis of the system with the ideal regenerators defines the upper bound of regeneration efficiency. The ideal regenerators assign each transmitted symbol to the closest element of the given alphabet (the corresponding stepwise transfer function is plotted in FIG. 2(a) by the dashed line).

At low SNR range the Shannon capacity is well approximated by the following expression:

C_{R}=n[1+m₊log₂(m₊)+m_{±}log₂(m_{±})] (5)

with the transition matrix elements (denote SNR as ρ):

m₊=m₋=([1+erf[\sqrt{Rρ/2}]/2])^{R}.

and

m_{±}=1−m₊

As the SNR increases, the distance between the closest neighbours reaches the optimal cell size, which is defined by the noise variance and the number of in-line regenerators,

$${d}_{opt}^{2} = 8 N κ / RW ( \frac{{e}^{2} {R}^{2}}{8 πκ} ) ,$$

where κ=+10R⁻¹ and W is the so-called Lambert W function (further, we use normalized value Δ=dₒₚₜ\sqrt{R/8N}. Therefore, with the growing signal power, the amplitude distribution remains equidistant, whereas the maximum entropy principle defines Maxwell-Boltzmann distribution as the optimal pdf for a fixed average energy constraint (which is in agreement with performed numerical optimization). Thus, with the growing SNR, a constant gap (that quantifies improvement) is seen between the regenerative channel and linear AWGN channel capacities (see detailed explanation below). The capacity improvement is defined by the noise variance and the number of regenerators:

$$Δ {C}_{R} = \frac{n}{2} {log}_{2} ( \frac{2 πe N}{{d}_{opt}^{ 2}} ) + nR \frac{{e}^{- {Δ}^{2}}}{Δ \sqrt{π}} {log}_{2} ( \frac{{e}^{- {Δ}^{2}}}{4 Δ \sqrt{π}} ) \qquad ( 6 )$$

An additional noise induced from a device itself NT can be incorporated in Eq. 6, by substituting N→N+RN_{T}. Moreover, one can estimate a critical value for the noise variance, which can be squeezed by the transformation. By using regenerative mapping technique, it is possible to define a half-width Δ of a plateau (superstable choice of parameters T′(x*)=0) around an alphabet point x* by solving T′(x*+Δ)=1 (in particular, for RFT the condition defines Δ=\sqrt{2}/3). Therefore, the noise is reduced if N/R+N_{T}≦Δ.

The maximum capacity gain due to regeneration (that is, the maximum regeneration efficiency) is observed for the binary channel. The capacity gain reflects the trade-off between the system complexity and capacity improvement. As the number of regenerators increases, the peak of the capacity gain shifts to a smaller SNR. Therefore, employing a low-SNR regime and using regeneration, one can achieve high transmission performance with low energy consumption. The minimum SNR value, when dₒₚₜ is achieved, defines the maximum capacity ratio to its linear analogue; that is, SNRₒₚₜ=dₒₚₜ²/4N. At this SNR value both analytic formulae Eq. 5-6 can be interpolated to describe capacity at the full range of the SNR.

### Numeric Validation

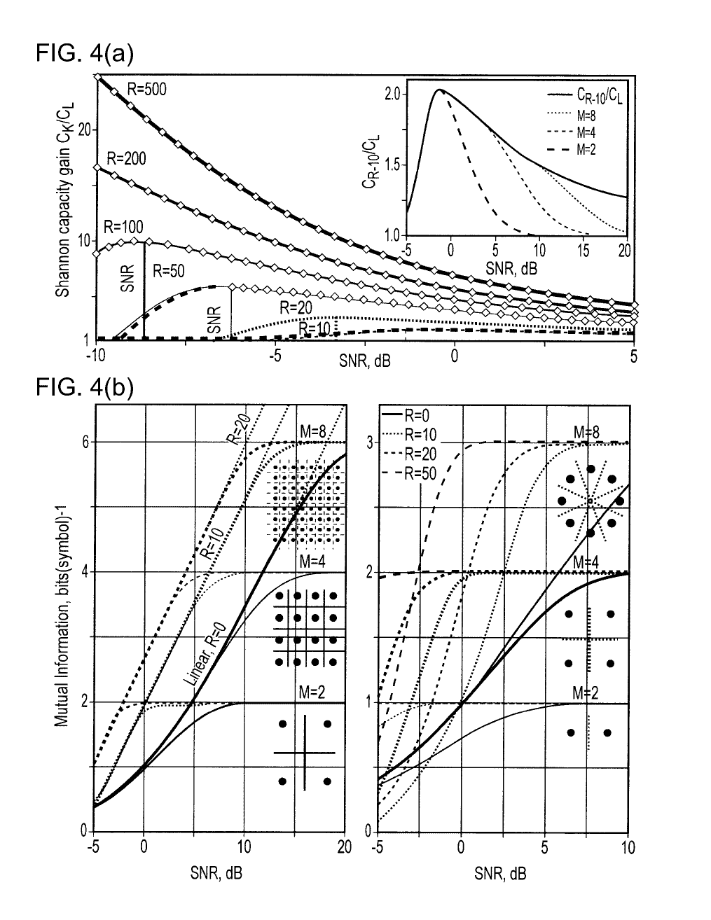

The analytical approximations shown by the dotted lines in FIG. 4(a) demonstrate an excellent agreement with the result of numerical computations of the Shannon capacity that exceeds the linear Shannon limit for different number of regenerators (here numerical optimization over all input pdf was performed). In FIG. 4(a), the analytical results from Eq. 5, which are shown by a dash-dotted line, and Eq. 6, which are shown by a dotted line, demonstrate an excellent agreement with numerically calculated results, which are shown by solid lines. The inset shows mutual information gain for M²-rectangular constellations approaching capacity gain. FIG. 4(b) shows the mutual information (here all symbols were assumed to be equiprobable) for rectangular (left panel) and ring (right panel) packing. Moreover, here we stress the importance of optimization for capacity calculations in nonlinear regenerative channels; otherwise, nonlinearity (even constructive one) will degrade system capacity.

### Discussion

Note that the nonlinear regenerative channel is a fundamentally different information channel from to linear AWGN channel, due to the constructive use of nonlinearity. In such nonlinear channels, the derived regenerative limit can be considered as the analogue of the Shannon linear limit—it is the maximum error-free transmission rate in regenerative channels. In fibre-optic channels, one can incorporate the impact of Kerr-nonlinearity and dispersion on the channel capacity as first order perturbation, whereas the main order is given by Eqs. 5-6.

The signal evolution in regenerative channel can be presented by the stochastic map—a discrete version of the Langevin equation for stochastic processes:

yₖ=T(yₖ₋₁)+ηₖ,k=1, . . . ,R,y₀=x+η₀,y=y_{R}

Above k is the discrete spatial/temporal index and T is the transfer function of the regenerative filter (see the channel scheme in FIGS. 2(a)-2(d)). The term ηₖ models the Gaussian noise with zero mean and the variance given by Nₖ added at k-th node.

The conditional pdf for the output at k-th node for each quadrature yₖ given the input yₖ₋₁ is found as

$$P ( {y}_{k} \text{\textbar} {y}_{k - 1} ) = \frac{1}{\sqrt{π {N}_{k}}} exp [ - \frac{{\vert {y}_{k} - T ( {y}_{k - 1} ) \vert}^{2}}{{N}_{k}} ]$$

Because of the Markovian property of the process, the conditional pdf of the received signal after propagation through R links, y_{R} given the input, x, is expressed by a product of single-step conditional probabilities:

P(y_{R+1}|y₀=x)=∫dy_{R} . . . dy₀P(y_{R}|y_{R-1}) . . . P(y₁|y₀=x)

Consequently, when Nₖ=N₀=constant, the conditional pdf can be expressed through Onsager-Machlup functional or action of the path given by Ŝ=Σ(yₖ−T(yₖ₋₁))² as follows:

$$P ( {y}_{R + 1} \text{\textbar} {y}_{0} ) = \int {\prod }_{k = 0}^{R} d {y}_{k} {e}^{- \hat{S} / {N}_{0}}$$

The conditional pdf for the sine-filtering model is given by:

$$P ( {y}_{R + 1} \vert {y}_{0} = {x}_{l} ) = \int {\prod }_{k = 0}^{R} d {y}_{k} {e}^{- {( {y}_{k + 1} - {y}_{k} - α sin ( β {y}_{k} ) )}^{2} \text{/} {N}_{0}}$$

We can reduce the problem to the previous case by representing the conditional probability of each link: through the decision boundaries probabilities, namely a sum of products of the probability of distorted point to be in the decision region Sₗ of the point xₗ, this is the same as in the first section Tₖₗ, and the conditional probability for the points in this area Sₗ. As a result, we are able to extract the small parameter ε=yₖ−xₗ<<1. Thus, using the definition of the alphabet points, namely xₗ=(2l+1)π/β where lε [symbol] , and expanding the sine function in series over E, the conditional pdf can be simplified as:

$$P ( {y}_{R + 1} \vert {y}_{0} = {x}_{k} ) = {\sum }_{l , {l}^{′} , {l}^{″}} {T}_{kl} {T}_{{ll}^{′}} ⋯ \frac{1}{\sqrt{{( π {N}_{0} )}^{R + 1}}} exp [ - \frac{\vert {y}_{R} - f ( {x}_{k} , {x}_{l} , {x}_{{l}^{′}} , … ) {\vert}^{2}}{{N}_{R + 1}} ]$$

where the residuary noise

$${N}_{R + 1} = {N}_{0} \frac{1 - {( 1 - q )}^{2 ( R + 1 )}}{1 - {( 1 - q )}^{2}}$$

with q=αβ<1. In the limit of high SNR we can consider the problem in the same way as in the case of the nearest neighbours, with the distortion leading to the error between the nearest neighbours only, so that, in the transfer matrix T the only the non-zero elements are diagonal \tilde{t} and neighbouring T̅. Hence, the formula can be written as:

$$P ( {y}_{R + 1} \vert {y}_{0} = {x}_{k} ) = \tilde{t} exp ( - \frac{\vert {y}_{R + 1} - \tilde{x} {\vert}^{2}}{{N}_{R + 1}} ) + \tilde{t} exp ( - \frac{\vert {y}_{R + 1} - {x}^{\pm } {\vert}^{2}}{{N}_{R + 1}} )$$

where notations with tilde account for the diagonal elements and ± for neighbouring points. Therefore, in the limit of high SNR, one can use the method of steepest descent, and the capacity of the system can be represented through the derived result of ΔC_{R} with the account of the residual noise N_{R+1}:

$${lim}_{SNR \to ∞} Δ {C}_{S} = Δ {C}_{R} - \frac{n}{2} {log}_{2} ( \frac{1 - {( 1 - q )}^{2 ( R + 1 )}}{1 - {( 1 - q )}^{2}} )$$

The introduced class of regenerative channels has information capacity that exceeds the Shannon capacity of the linear AWGN channel. The gain is achieved by noise squeezing due to the introduced mapping filter that creates attraction regions around the stable alphabet. The model is generic and the obtained results can be applied to a wide range of physical problems. The results reveal a fascinating new aspect of the interplay between stochastic processes and system nonlinearity, stressing the impact on the channel capacity.

### Upper Bound of Regeneration Efficiency

The definition of the Shannon capacity for an arbitrary channel (in what follows, capacity C is per unit bandwidth) involves maximizing the mutual information functional [2]:

$$C = {max}_{P ( x )} \int D x D y P ( x ) P ( y \vert x ) {log}_{2} \frac{P ( y \vert x )}{\int D X P ( x ) P ( y \vert x )} \qquad ( 7 )$$

over all valid input probability distributions P(x) subject to the power constraint ∫DxP(x)|x|²≦S. Here, statistical properties of the channel are given by the conditional input-output probability density function (PDF) P(y|x). The n-dimensional vectors y and x correspondingly represent output and input signals. Further, the n dimensional problem can be reduced to the n independent one-dimensional lattices with symmetrical equidistant alphabet points. Additionally, the same notations x and y are used for one-dimensional input and output (see [2]).

The capacity analysis of the system with the ideal regenerators defines the upper bound of regeneration efficiency. The ideal regenerators assign each transmitted symbol to the closest element of the given alphabet. The conditional pdf of such a system is defined through the matrix elements [3]:

P(y=xₖ|xₗ)=∫ₛ_{ₖ}dx′P_{C}(x′|xₗ)=Tₖₗ (8)

where P_{C} is a Gaussian conditional pdf. This means that the ideal regenerator assigns diffused point x′ (originated from the input point xₗ) to the closest neighbor xₖ in the decision area Sₖ. The transition matrix is defined as follows:

$${T}_{kl} = \frac{1}{2} ( erf [ {Δ}_{kl}^{+} ] - erf [ {Δ}_{kl}^{-} ] ) , {Δ}_{kl}^{\pm } = ( {x}_{k} + {x}_{k \pm 1} - 2 {x}_{l} ) \sqrt{\frac{R}{8 N}} \qquad ( 9 )$$

the latter is the normalized closest neighbour distance as follows Δ=d\sqrt{R/8N}. Due to the Markovian nature of the stochastic system, the overall transition matrix after R regenerative segments reads as M=T^{R}.

At low SNR range, the channel is binary in each of then dimensions. Therefore, capacity is well approximated by the following expression:

C_{R}=n(1+m₊log₂m₊+m_{±}log₂m_{±})

with the transition matrix elements (denote SNR as ρ): diagonal

$${m}_{+} = {m}_{-} = {( [ 1 + erf [ \sqrt{\frac{R ρ}{2}} ] ] \text{/} 2 )}^{R}$$

and non-diagonal m_{±}=1−m₊.

As SNR rises, the closest neighbours distance reaches the optimal cell-size d=dₒₚₜ, which defines the optimum size of the decision boundary determined by the noise variance and the number of in-line regenerators. A further rise of SNR results in an increase in the number of alphabet points distributed equidistantly with the constant closest neighbours distance dₒₚₜ. Thus, at high SNR the system is characterized by the optimal decision boundaries that are sufficiently large, in comparison with the noise variance, to suppress noise effectively. Therefore, with the growing signal power, the amplitude distribution of K-points alphabet x_{k=1 . . . K} remains constant (that is equidistant with the closest neighbours distance dₒₚₜ), whereas the maximum entropy principle defines Maxwell-Boltzmann distribution as the optimal pdf for a fixed average energy constraint. Subsequently, the output pdf can be well approximated as qₖ=αe^{-βx}^{ₖ}^{²}, where constants are chosen to satisfy conditions as Σₗ₌ₖ^{K}qₖ=1 and Σₗ₌ₖ^{K}qₖ|xₖ|²=S+N/R. In the limit of high SNR and/or large number of regenerators, when dimensionless parameter Δ=d\sqrt{R/8N}<<1, the noise is sufficiently squeezed and the faulty decision occurs only between the nearest neighbours. Further we consider the problem in the approximation of the closest neighbours, so the transition matrix of the span has the form:

$$T = ( \begin{matrix}… & … & … & … & … & … & … & … & … \\ … & 0 & \overline{t} & \tilde{t} & \overline{t} & 0 & … & … & … \\ … & … & 0 & \overline{t} & \tilde{t} & \overline{t} & 0 & … & …\end{matrix} ) \qquad ( 10 )$$

with the elements given by \tilde{t}=erf(Δ) and t̅=(1−\tilde{t})/2.

In this approximation, the overall transition matrix M:

$$M = ( \begin{matrix}… & … & … & … & … & … & … & … & … \\ … & 0 & \overline{m} & \tilde{m} & \overline{m} & 0 & … & … & … \\ … & … & 0 & \overline{m} & \tilde{m} & \overline{m} & 0 & … & …\end{matrix} ) \qquad ( 11 )$$

with

$$\tilde{m} ≅ {\tilde{t}}^{R} ≅ 1 - \frac{{Re}^{- {Δ}^{2}}}{Δ \sqrt{π}}$$

and m̅=(1−\tilde{m})/2. Thus, the conditional entropy equals to:

$${H}_{y \vert x} ≅ - n ( \tilde{m} {log}_{2} \tilde{m} + 2 \overline{m} {log}_{2} \overline{m} ) ≅ - n \frac{{Re}^{- {Δ}^{2}}}{Δ \sqrt{π}} {log}_{2} ( \frac{{Re}^{- {Δ}^{2}}}{4 Δ \sqrt{π}} ) \qquad ( 12 )$$

whereas the output conditional pdf:

$${H}_{y} = - {\sum }_{l = k}^{K} {q}_{k} {log}_{2} {q}_{k} ≅ \frac{n}{2} {log}_{2} ( \frac{2 π e ( S + N \text{/} R )}{{d}_{opt}^{2}} ) \qquad ( 13 )$$

By maximizing the capacity given by the difference of the aforementioned entropies, one obtains the optimum cell size, which can be approximated by

$${d}_{opt}^{2} = \frac{8 N κ}{R} W ( \frac{{R}^{2} {e}^{2}}{8 πκ} ) ,$$

κ=1+10R⁻¹, where W is the so-called Lambert W function, also referred to as the Omega function or product logarithm. Note that the considered channel is significantly discrete, and the maximum closest neighbours distance depends on noise properties and regeneration parameters.

Thus, with the growing SNR one can observe a constant gap (quantifying improvement) between the regenerative channel and linear AWGN channel capacities. The capacity improvement is defined by the noise variance and the number of regenerators:

$$Δ {C}_{R} = \frac{n}{2} {log}_{2} ( \frac{2 π eN}{{d}_{opt}^{2}} ) + n \frac{{Re}^{- {Δ}^{2}}}{Δ \sqrt{π}} {log}_{2} ( \frac{{Re}^{- {Δ}^{2}}}{4 Δ \sqrt{π}} ) \qquad ( 14 )$$

The minimum SNR value, when dₒₚₜ is achieved, defines the maximum capacity ratio to its linear analogue, that is SNRₒₚₜ=dₒₚₜ²/(4N). At this SNR value, both analytic formulae Eqs. 8-9 can be interpolated to describe capacity at the full range of SNR.

The numerical optimization was carried out by applying the gradient search algorithm [33], which allows one to optimize the function simultaneously over signal distribution P(x) and input modulation x for given constraints (here, power constraint ∫DxP(x)|x|²≦S and ∫DxP(x)=1). This enabled us to study the problem thoroughly (without limitations on pdf) and with a good level of precision. In addition, we independently carried out optimization by using the conventional Arimoto-Blahut algorithm [5-6], an iterative method that minimizes the rate-distortion functions of arbitrary finite input/output alphabet sources. Both methods produced results that were in good agreement.

The characteristic peculiarity of the regenerative channel is its discreteness; here, the size of the alphabet was a flexible parameter, which was also incorporated in the optimization procedure. An input modulation x is defined by the smooth nonlinear transfer function of the regenerator. In the case of RFT, the values of x were defined by the parameters of the RFT (see Eqs. [1-3]).

In the case of the ideal regenerator, we optimized over all interval of x, whereas a stepwise transfer function was adapted to the alphabet as in Eq. 3. Thus, we achieved a maximum regenerative capacity as a function of SNR and the number of ideal regenerators. Simultaneous optimization was possible due to the properties of the gradient search algorithm. Consequently, a thorough and detailed optimization was performed in order to calculate the Shannon capacity as an optimization functional defined in Eq. 1.

### REFERENCES

[1] Shannon, C. E. A mathematical theory of communication. Bell Syst. Tech. J. 27, 379-423, 623-656 (1948).
[2] Mitra, P. P. & Stark, J. B. Nonlinear limits to the information capacity of optical fibre communications. Nature 411, 1027-1030 (2001).
[3] Essiambre, R. J., Foschini, G. J., Kramer, G. & Winzer, P. J. Capacity limits of information transport in fiberoptic networks. Phys. Rev. Lett. 101, 163901 (2008).
[4] Ellis, A. D., Zhao, J. & Cotter, D. Approaching the nonlinear Shannon limit. J. Lightwave Technol. 28, 423-433 (2010).
[5] Richardson, D. J. Filling the light pipe. Science 330, 327-328 (2010).
[6] Liu, X. et al. Phase-conjugated twin waves for communication beyond the Kerr nonlinearity limit. Nature Photonics 7, 560-568 (2013). [7] Hillerkuss, D. et al. 26 Tbit/s line-rate super-channel transmission utilizing all-optical fast Fourier transform processing. Nature Photonics 5, 364-371 (2011).

[8] Wang, J. et al. Terabit free-space data transmission employing orbital angular momentum multiplexing. Nature Photonics 6, 488-496 (2012).

[9] Parmigiani, F. et al. Progress in multichannel all-optical regeneration based on fiber technology. IEEE J. Select. Topics in Quantum Electron. 18, 689-700 (2012).
[10] Vasilyev, M. & Lakoba, T. I. All-optical multichannel 2R regeneration in a fiber-based device. Opt. Lett. 30, 1458-1460 (2005).
[11] Lakoba, T. I. & Vasilyev, M. A new robust regime for a dispersion-managed multichannel regenerator. Opt. Exp. 15, 10061-10074 (2007).
[12] Boscolo, S., Blow, K. J. & Turitsyn, S. K. All-optical passive 2R regeneration for N40 Gbit/s WDM transmission using NOLM and novel filtering technique. Opt. Commun. 217, 227-232 (2003).
[13] Croussore, K., Kim, C. & Li, G. All-optical regeneration of differential phase shift keying signals based on phase-sensitive amplification. Opt. Lett. 29, 2357-2359 (2004).
[14] Slavik, R. et al. All-optical phase and amplitude regenerator for next generation telecommunications systems. Nature Photonics 4, 690-695 (2010).
[15] Kakande, J. et al. Multilevel quantization of optical phase in a novel coherent parametric mixer architecture. Nature Photonics 5, 748-752 (2011).
[16] Nakazawa M., Yamada E., Kubota H. & Suzuki K. 10 Gbit/s soliton data transmission over one million kilometres. Elect. Lett. 27, 1270-1272, (1991).
[17] Matsumoto, M. Fiber-based all-optical signal regeneration. IEEE J. Sel. Top. Quantum Electron. 18, 738752 (2012).
[18] Umeki, T. et al. Multi-span transmission using phase and amplitude regeneration in PPLN-based PSA. Opt. Express 21, 18170-18177 (2013).
[19] Turitsyn, K. S & Turitsyn, S. K. Nonlinear communication channels with capacity above the linear Shannon limit. Opt. Lett. 37, 3600-3602 (2012).
[20] Sorokina M. A., Sygletos S. & Turitsyn S. K. Optimization of cascaded regenerative links based on phase sensitive amplifiers. Opt. Lett. 38, 4378-4381 (2013).
[21] Martinis, J. M., Devoret, M. H. & Clarke, J. Energy level quantization in the zero-voltage state of a current biased Josephson junction. Phys. Rev. Lett. 55, 1543-1546 (1985).
[22] Angeli, D., Ferrell, J. F. & Sontag, E. D. Detection of multistability, bifurcations, and hysteresis in a large class of biological positive-feedback systems. Proc. Nat. Acad. Sci. USA 101, 1822-1827 (2004).
[23] Koshino, K. & Shimizu, A. Quantum Zeno effect by general measurements. Phys. Rep. 412, 191-275 (2005).
[24] Siegman, A. E. Fiber Fourier optics. Opt. Lett. 26, 1215-1217 (2001).
[25] Nakazawa, M. et al. Ideal distortion-free transmission using optical Fourier transformation and Fourier transform limited optical pulses. IEEE Photon. Technol. Lett. 16, 1059-1061 (2004).
[26] Guan P. et al. Single-channel 1.28Tbit/s-525 km DQPSK transmission using ultrafast time-domain optical Fourier transformation and nonlinear optical loop mirror. IEICE Transactions on Communications 94-b, 430-436 (2011).
[27] Hillerkuss D. et al. Simple all-optical FFT scheme enabling Tbit/s real-time signal processing. Opt. Express 18, 9324-9340 (2010).
[28] Mulvad H. C. H. et al. Ultra-high-speed optical serial-to-parallel data conversion by time-domain optical Fourier transformation in a silicon nanowire. Opt. Express 19, B825-B835 (2011).
[29] Chen H. et al. 5200 Gbit/s all-optical OFDM transmission using a single optical source and optical Fourier transform real-time detection, Opt. Express 19, 21199-21204 (2011).
[30] Sorokina, M. A. Design of multilevel amplitude regenerative system. Opt. Letters (in press).
[31] Crutchfield, J. R., Nauenberg, M. & Rudnick J. Scaling for external noise at the onset of chaos. Phys. Rev. Lett. 46, 933-935 (1981).
[32] Reimann, P. & Talkner, P. Probability densities for discrete dynamical systems with weak noise. Hel. Phys. Acta 63, 845-846 (1991).
[33] www.mathworks.co.uk/help/optim/ug/fmincon.html

1. An optical communication method comprising:
encoding data on an optical signal using a modulation alphabet;
transmitting the optical signal on a non-linear optical channel;
regenerating the optical signal at a regeneration filter on the non-linear optical channel;
receiving the optical signal at a destination; and
decoding the data from the optical signal,
wherein regenerating the optical signal comprises applying a regenerative transfer function T(x) to the optical signal at the regeneration filter, and
wherein the regenerative transfer function T(x) satisfies the conditions:
T(x*)=x*,
T″(x*)=0, and

|T′(x*)|<1,
where x* represents each symbol of the modulation alphabet.

2. A method according to claim 1, wherein the regenerative transfer function T(x) satisfies the condition |T′(x*)|=0 at each symbol x* of the modulation alphabet.

3. A method according to claim 1 including regenerating the optical signal at a plurality of regeneration filters disposed in series along the non-linear communication channel.

4. A method according to claim 3, wherein each regeneration filter applies the same regenerative transfer function.

5. A method according to claim 1, wherein the modulation alphabet defines a constellation of order 8.

6. A method according to claim 1, wherein the non-linear channel comprises a silica-based optical fibre.

7. A method according to claim 1 including applying the regenerative transfer function to both quadratures of the optical signal.

8. A method according to claim 7, wherein the step of applying the regenerative transfer function comprises:
separating two quadratures of the optical signal,
applying the regenerative transfer function to each quadrature, and
combining the regenerated quadratures.

9. A method according to claim 8, wherein the step of separating two quadratures comprises applying phase sensitive amplification to the optical signal.

10. A method according to claim 1, wherein the modulation alphabet defines a rectangular constellation.

11. A method according to claim 1, wherein the regenerative transfer function is a Fourier transform of a step-wise regenerator function.

12. A method according to claim 11, wherein the regenerative transfer function T(x)=x+α sin βx, where α and β are parameters determined by the configuration of the regenerative filter.

13. A method according to claim 12, wherein the step of applying the regenerative transfer function comprises:
splitting the optical signal into a reference signal and an input signal;
separating the input signal into two quadratures;
applying a sine transformation to each of the two quadratures;
combining the two quadratures into an output signal; and
adding the output signal to the reference signal.

14. A method according to claim 13, wherein the step of applying a sine transformation to each of the two quadratures comprises performing four-wave mixing with a continuous wave and extracting an imaginary part of the result thereof.

15. A method according to claim 1, wherein the optical signal has a wavelength in the range 1400-1600 nm.

16. A method according to claim 15, wherein the step of encoding data on the optical signal comprising performing wavelength division multiplexing.

17. A regeneration filter for regenerating an optical signal transmitted on an optical fibre, the regeneration filter comprising:
an input for receiving an optical signal
an optical splitter for dividing the optical signal into a reference signal and an input signal;
an optical separator for separating the input signal into a first quadrature and a second quadrature;
an optical transformation component for applying a sine transformation to the first quadrature and the second quadrature; and
an optical combiner for combining the sine transformation of the first quadrature and second quadrature and adding them to the reference signal.
